(19) United States
(12) Patent Application Publication
(10) Pub. No.: US 2011/0045439 A1
(43) Pub. Date: Feb. 24, 2011

(54) One piece endosseous titanium or zirconia or high stregth polymer dental implant bearing a bonded ceramic or polymer transmucosal abutment component

(76) Inventors: Aris-Petros Tripodakis, Athens (GR); Georgios Iliadis, Athens (GR)

Correspondence Address: Allen R. Kipnes, Esq., Watov & Kipnes P.C., P.O. Box 247, Princeton Junction, NJ, 08550, US

(21) Appl. No.: 12/800,440

(22) Filed: May 14, 2010

(30) Foreign Application Priority Data
Nov. 16, 2007 (GR) 20070100691
Nov. 13, 2008 (GR) PCT/GR2008/000066

(51) Int. Cl. A61C 8/00

(52) U.S. Cl. 433/174

(57) ABSTRACT

The invention consists of a one-piece dental implant containing an endosseous part made of Ti or Zirconia high strength polymer that is screw-shaped, responsible for the mechanical fitting and biological integration into the jaw bone and that bears a transmucosal extension that acts as the supporting core of the abutment and the solid unifying element between the endosseous and the restorative part. This extension bears an esthetic coating of reduced toughness that can be ground intraorally in its coronal part to adapt the dental prosthesis after the implant has been fitted in position. The coating is ceramic or glass-ceramic or polymer and is bonded on the transmucosal-coronal extension by fusion, heat pressing or by an adhesive.

### FIELD OF THE INVENTION

A one-piece endosseous/transmucosal dental implant, bearing a thick tooth colored coating bonded on the abutment extention, to be used for the esthetic prosthetic to restoration of missing teeth by means of a one stage surgical procedure.

### BACKGROUND OF THE INVENTION

Dental implants have been successfully used for the replacement of missing teeth. Usually they have been applied by surgical procedures in two faces:
The initial surgical procedure involves the endosseous placement of the implants underneath the mucosa of the edentulous area.
The second stage surgery involves the uncovering of the mucosa and connection with the abutment on which the dental prosthesis is fixed.

The different types of dental implants that have been introduced thus far, mainly consisting of Ti, can be mechanically connected in the second stage with a separate transmucosal abutment component also consisting of Ti, supporting the fixation of the artificial teeth. Such a connection inherently and inevitably has a mechanical drawback in which a retaining screw eventually loosens or breaks. Furthermore such a connection also has a biological drawback in which the junction of the implant-abutment forms a micro gap, which acts as a bacterial trap.

The esthetic demands of the cervical part of the restorations call for biocompatible transmucosal materials that have the appearance and the optical behaviour comparable to natural tooth substances. Thus an assortment of ceramic abutments has been introduced. These abutments, with varying mechanical properties, adopted the design originally applied in Ti abutments. They consist of a hollow tube basic form that provides access for the head of a connecting screw that stabilizes the abutment on the implant. This design while effective for the mechanical properties of a metallic abutment, unavoidably introduces severe tensile stresses in the area around the head of the connecting screw when lateral forces are applied on the abutment. Such stresses are incompatible and at times detrimental to the mechanical properties of ceramic materials that can successfully endure compressive stresses but are extremely vulnerable to tensile stresses. To overcome this inadequacy the use transmucosal abutments made of stronger tooth colored materials such as pure Al₂O₃ or ZrO₂ was introduced. Nevertheless the extreme toughness of these materials prohibits intraoral shape modifications, while their strength is expected to be reduced after prolonged use. Moreover their optical quality involves unfavorable opacity.

The need for a revised design applied in conjunction with softer and easier to clinically modify ceramic materials combined with biologic, mechanical and esthetic improvements is therefore understandable. These requirements call for softer ceramic materials possessing optical qualities and depth of translucency similar to natural tooth substances. In addition, the ceramic materials must be designed in a manner that would eliminate tensile stresses and favor compressive stresses in combination with the elimination of the implant-abutment connection drawbacks.

One stage surgery for implant placement (the endosseous implant placement being immediately followed by the transmucosal abutment connection, combined or not with the installation of an immediate provisional restoration) made possible the use of one piece implant/abutment fixtures. They basically involve an endosseous part possessing a rough threaded surface that results coronally to an implant head with a smooth metal collar large in height, designated for soft tissue contact. The implant head (cylindrical, conical, tapered or scalloped) is joined either directly to the prosthetic superstructure or to an other intermediate coronal part, metallic or ceramic. These designs fully retain the mechanical drawback of the screw joint. Furthermore the biological drawback of the implant-abutment junction's micro gap, while still present, is positioned farther coronally, away from the bone level but still quite deep under the soft tissues.

Another category of one stage implants designed for immediate fixation of a provisional restoration and loading involves one piece implant/abutment fixtures that extend coronally beyond the transmucosal part, to a prosthetic head for the direct installation of the restoration. One international application of such design has already been published under the Patent Cooperation Treaty (“Immediate-load dental implants” by Kandemann S. and Trenkler C., PCT: WO 2007/O25784 A2), and another one under the European Patent office (“One-part implant with hydroxylated soft tissue contact surface” by Schwarz F. et al., EP 1 825 828 A1). Moreover, one-piece dental implants in both Ti (i.e. NobelDirect, NobelBiocare, Gotteborg, Sweden) and Zirconia (i.e. whiteSKY Zirconium Implant, bredent medical, Senden, Germany) are presently commercially available.

This latter approach eliminates the implant/abutment junction and fully abolishes all previously mentioned drawbacks. Nevertheless the abutment and coronal part are a direct extension of the implant material, Ti or Zirconia. In both occasions the endosseous material is one and the same with this extension. Therefore the metallic extension of a Ti implant does not meet the esthetic requirements of the soft tissues. Furthermore, if the implant material is Zirconia, its transmucosal element is too tough to modify intraorally, while its opacity is optically unfavorable. Moreover the position, inclination, size and height of its prefabricated crown retaining intraoral projection can effectively meet the clinical requirements of a restorable abutment only coincidentally, providing minimal leeway for the required necessary modifications by the existing clinical anatomical conditions. In addition, its predetermined flat finish line for the crown margin does not have the ability to follow the periimplant soft tissue crest in direct and intimate relationship.

These shortcomings could be overcome by a design that involves a one piece implant/abutment fixture that extends coronally beyond the transmucosal part, to a prosthetic head incorporating an amendable by intraoral grinding esthetic material for the direct installation of the restoration. Such an approach has appeared in an international application that has been published under the Patent Cooperation Treaty (“One-part dental implant” by Beekmans J.C.S., PCT: WO 01/34056 A1). That invention refers to a tooth shaped one-piece ceramic implant bearing a softer ceramic coating coronally. Its endosseous element tapers to a root form with oval cross-section that can only be fitted into the jaw bone only by punching. Therefore the mechanical anchorage of the endosseous part not being attained by screw retention is simply limited to friction and thus the acquired initial stability of the implant is expected to be inadequate for immediate loading. Furthermore, no reference has been made regarding the nature of the interface between the supporting core and the ceramic coating. Possibly, these are the reasons why the invention that dates since 2001, is not effective and has not been commercially introduced.

### SUMMARY OF THE INVENTION

The one-piece dental implant of the present invention comprises a Ti or zirconia or high-strength polymer endosseous screw shaped part which can be fitted in the jaw bone, bearing a transmucosal narrower extension core coated by an esthetic ceramic or glass-ceramic or polymer material that is bonded on the core by fusion or heat to pressing or by means of an adhesive that protrudes intraorally in order to support the dental prosthesis.

The present invention involves a one-piece Ti or Zirconia or high-strength Polymer implant incorporating an endosseous screw-shaped part with a transmucosal abutment-coronal extension that bears a thick bonded ceramic or glass-ceramic or polymer coating. The moderate toughness of this coating ensures the ease of its intraoral modification to accommodate a superimposed restoration and provides the necessary optical qualities and biocompatibility in the cervical soft tissue environment. The coating is bonded either by an adhesive media or it is fired directly on the implant extension, fused or heat pressed. Thus the implant extension is acting as the supporting core of the abutment and crown bearing part and as the solid unifying element of the one-piece hybrid dental implant.

The aim of the invention is to combine the advantages of a one piece dental implant with the presence of a bonded transmucosal esthetic coating with mechanical properties that ensure the ease of its intraoral modification. The coating acquires the necessary mechanical endurance by assuming the appropriate design that allows the exertion of exclusively compressive forces on the fragile ceramic or glass-ceramic or polymer material.

### BRIEF DESCRIPTION OF THE DRAWINGS

The following drawings in which like reference characters indicate like parts are illustrative of embodiments of the invention and are not intended to limit the invention as encompassed by the claims forming part of the invention.

FIG. 1 is a side view of an embodiment of a one-piece dental implant in accordance with the present invention;

FIG. 2 is a cross-section elevational view showing the transmucosal portion of the one-piece dental implant shown in FIG. 1;

FIG. 3 is a top view of the transmucosal portion of the one-piece dental implant shown in FIG. 1;

FIG. 4 is a side view similar to FIG. 1 showing a transmucosal and restorative abutment coating overlaying a prismatic extension supporting core of the transmucosal portion;

FIG. 5 is a cross-section elevational view of the embodiment shown in FIG. 4;

FIG. 6 is a top view of the transmucosal portion shown in FIG. 4;

FIG. 7 is a side view of a further embodiment of a one-piece dental implant in accordance with the present invention showing a transmucosal and abutment coating overlaying a prismatic extension supporting core of the transmucosal portion;

FIG. 8 is a cross-section elevational view of the embodiment shown in FIG. 7;

FIG. 9 is a side view of a still further embodiment of a one-piece dental implant in accordance with the present invention; and

FIG. 10 is a cross-section elevational view of the embodiment shown in FIG. 9.

### DETAILED DESCRIPTION OF THE INVENTION

The advantages of the invention are described as follows:

Biologic advantages: The fixture consists of one piece, while the interface among the implant material and the abutment coating is fully sealed due to the acquired bond, therefore the implant-abutment junction's micro gap acting as a bacterial trap does not exist. The retrieval or interchange of the transmucosal element is also not possible and the adverse biological consequence of the disruption of the intimate soft tissue adaptation is eliminated. Moreover the preparation finish-line that will accommodate the definitive crown margins is finalized by intraoral preparation of the coating after the healing and maturation of the soft tissue has been fully accomplished. Thus the crown margins can attain a biologically ideal, direct and to intimate relationship with the periimplant soft tissue, after the architecture of its free gingival margin is completely stabilized.

Mechanical advantages: The absence of a screw joint between implant and abutment eliminates the common mechanical problems of screw loosening or fracture. The is tooth colored ceramic or glass-ceramic coating material is bonded, fused or heat pressed on the strong Ti or Zirconia or high-strength polymer core extension of the implant. Therefore all the hazardous tensile forces are eliminated and the esthetic ceramic material is exposed exclusively to the tolerable compressive forces. Moreover the ceramic material that covers the core extension coronally due to its reduced toughness can be easily modified by intraoral preparation in order to meet the morphological clinical prerequisites of a restorable abutment for a full coverage restoration.

Esthetic advantages: The dark shade created on the soft tissues by the transmucosal metallic Ti surface is eliminated as it is covered by the ceramic coating material. The translucent ceramic material emerging through the transparent soft tissue crest allows its internal illumination by transmitting the light from the crown to the transmucosal part in a similar manner as the natural tooth illuminates its root and the adjacent gingival margin. Moreover the feasible intraoral preparation meets the esthetic prerequisites of a mildly sub-crestal finish line to accommodate the definitive crown margins in an esthetic relationship with the periimplant soft tissues.

The description of the invention is linked separately to its three different area levels:

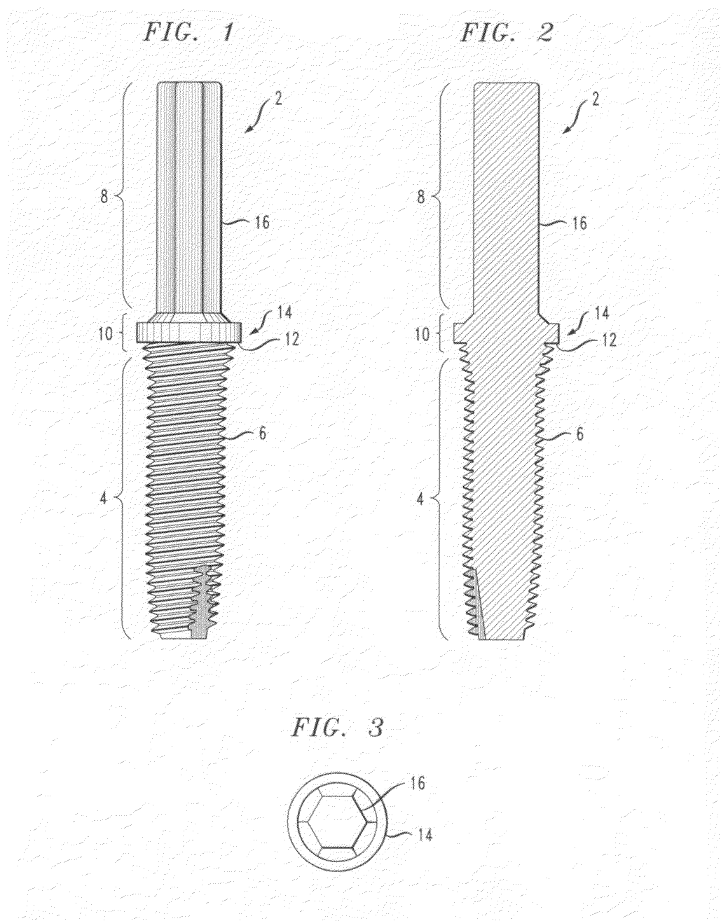

Referring to the drawings and particularly to the embodiment shown in FIGS. 1-3, the endosseous part 4 of the implant 2 can adopt most of the already commercially available and clinically successful configurations of regular dental implants designed for immediate loading. Namely it ought to be screw type, cylindrical or root formed, in order to attain adequate primary stability achieved upon insertion by self-tapping via threads 6 into the jaw bone (not shown). Its surface ought to be rough in order to rapidly promote osseointegration. Its length can vary preferably from 10 to 15 mm and its width preferably from 3.25 to 5 mm. It may consist of a strong material such as either commercially pure Ti, or Ti alloy or Zirconia or high-strength polymer.

In the transmucosal part 8, the implant 2 consists of a cervical part 10 adjacent to the osseous crest and soft tissue. The endosseous material immediately above the bone crest widens forming a platform 12 on the lower surface of a collar 14 that aims to prevent over-screwing the implant into the prepared osseous bed during its insertion. For this purpose it has an increased diameter that varies from 3.5 to 4.5 mm. The collar 14 varies in height from 1.0 to 4.00 mm. The implants with the lower collar height in this area are to be used in the healed edentulous sites, whereas the ones with the higher collar height in the immediate extraction sites where the implant is seated in a deeper position into the socket. The surface of the collar is smooth and designated for the soft tissue contact.

Immediately above the collar 14 of the endosseous part 4 of the implant comprised of Ti or Zirconia or high-strength polymer is extended coronally forming a cylindrical or prismatic projection 16 (i.e. hexagonal) (see FIG. 3) or conical that gradually is transformed into a prismatic form of reduced diameter of 2.5 to 3.0 mm. The implant extension acts as the supporting core of the abutment and the solid unifying element between the endosseous and the restorative part of the hybrid implant. The connection of the extension with the main body of the implant slopes and widens forming a foundation base, in order to attain increased strength. Moreover the prismatic morphology of the extension 16 acts to prevent rotation of the bonded coating.

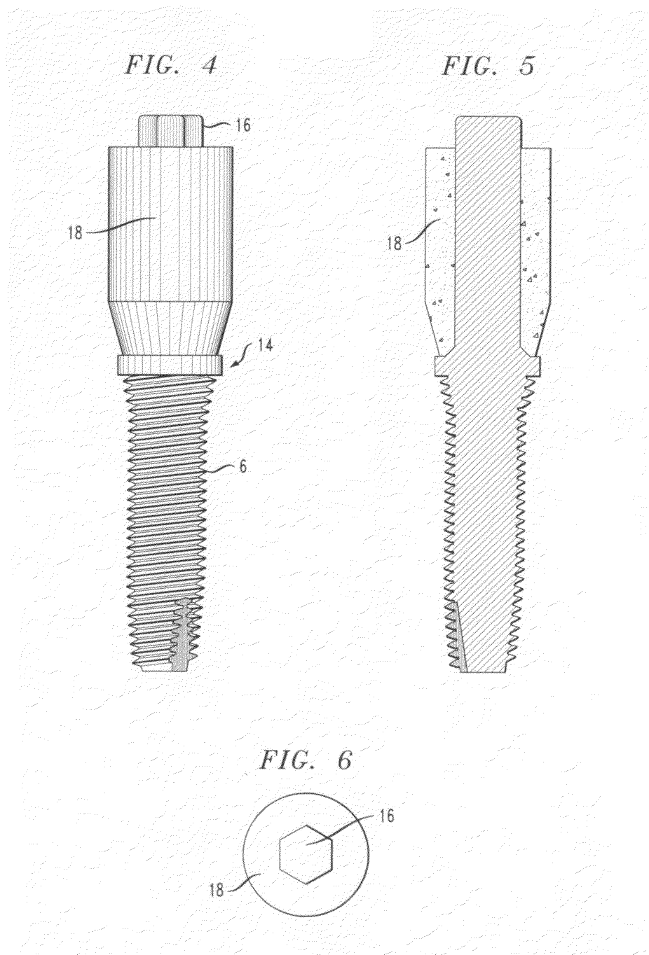

The extension is covered by a ceramic or glass-ceramic or polymer coating 18 as shown in FIGS. 4-6 that is bonded, fused or heat pressed on the Ti or Zirconia or the high-strength polymer core material. The thickness of the coating material gradually increases starting from 0.5 mm thus forming a platform switch cervically of 0.5 mm in order to prevent the potential crestal bone resorption around the material interface (diameter difference of the platform of the endosseous head and the emerging cervical veneered part of the transmucosal abutment). The coating material reaches its maximum thickness of 1.5 mm thus forming a cylindrical transmucosal element of 5.0 to 6.00 mm in diameter.

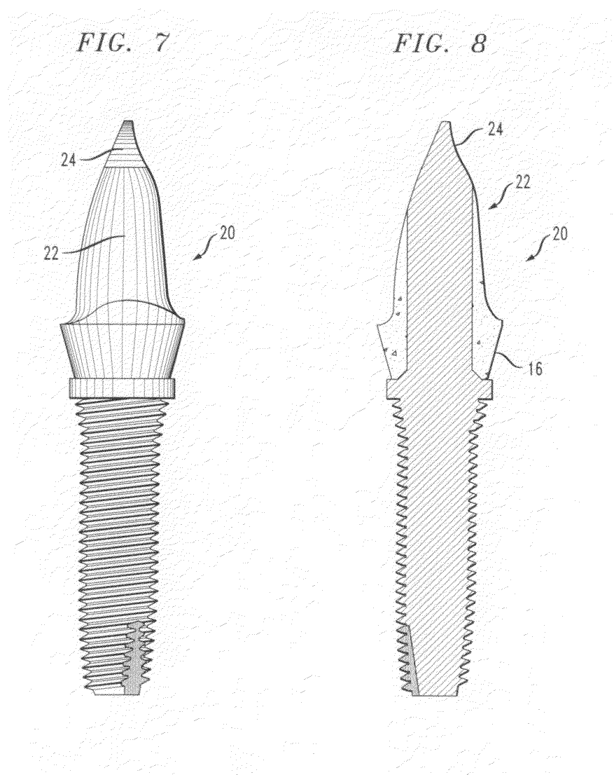

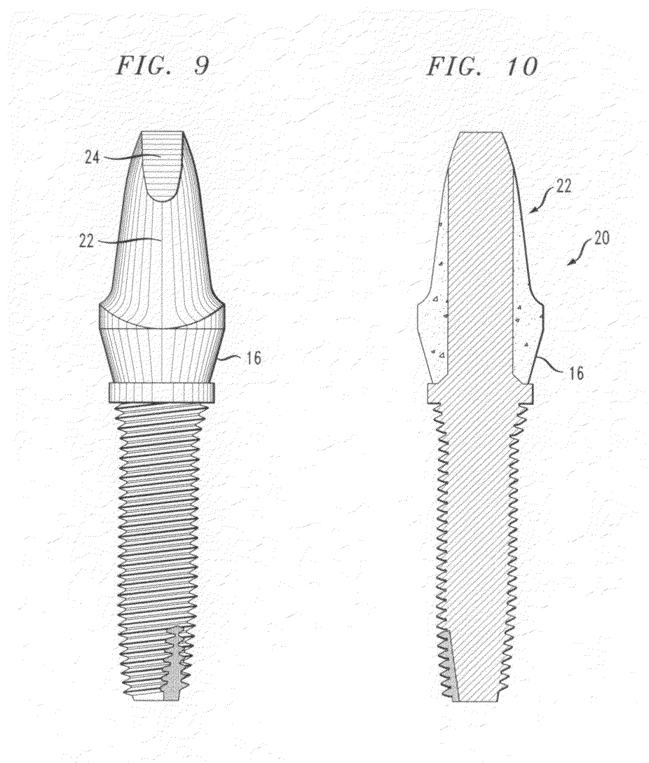

Referring to FIGS. 7-10, a restorative abutment part 20 the implant material extends coronally and acts as the reinforcing core of the transmucosal and crown to part of the restoration and typically has a total height that varies from 10.0 mm to 15.0 mm. Coronally, its tip 22 with rounded edges, is not covered by the coating and provides an external grip (1.5 mm in diameter hexagonal and 2 mm in height) to be engaged by the rotating instrument (not shown) that is used during the insertion by screwing the fixture into the prepared osseous bed. The coating material 18 that covers the transmucosal part 8 extends on the coronal part as well, in a uniform thickness of 1.0 to 1.5 mm providing an amendable tooth preparation shell in the restorative level of the abutment.

1. The one-piece dental implant consists of a Ti or Zirconia or high-strength polymer endosseous screw shaped part which can be fitted in the jaw bone, bearing a transmucosal narrower extension core coated by an esthetic ceramic or glass-ceramic or polymer material that is bonded on the core by fusion or heat pressing or by means of an adhesive and that protrudes intraorally in order to support the dental prosthesis.

2. The one-piece endosseous implant according to claim 1 is characterized as a hybrid in that it consists of two materials (that of the endosseous part bearing a thinner transmucosal abutment extension made of Ti or Zirconia or high-strength polymer that can be fitted by screwing into the jaw bone and that of the esthetic coating of the extension core made of low fusing ceramic or glass-ceramic material or polymer) chemically connected with each other by the means described above.

3. The one-piece dental implant according to claim 2 is characterized in that the endosseous part consists of Ti or Zirconia or high-strength polymer which is screw-shaped and is responsible for the mechanical fitting and biologic integration into the jaw bone, whereas its transmucosal extension acts as the supporting core of the abutment and the solid unifying element between the endosseous and the restorative part bearing an esthetic coating of reduced toughness that can be ground intraorally to adapt the dental prosthesis after the implant has been fitted in position.
